(19) United States
(12) Patent Application Publication
(10) Pub. No.: US 2026/0052552 A1
(43) Pub. Date: Feb. 19, 2026

(54) METHOD AND USER EQUIPMENT FOR SIDELINK COMMUNICATION USING CARRIER AGGREGATION

(71) Applicant: Apple Inc., Cupertino, CA (US)

(72) Inventors: Zhibin Wu, Los Altos, CA (US); Chunxuan Ye, San Diego, CA (US); Haijing Hu, Los Gatos, CA (US); Peng Cheng, Beijing (CN)

(21) Appl. No.: 19/103,881

(22) PCT Filed: Aug. 16, 2023
(86) PCT No.: PCT/US2023/030317

§ 371 Date: Feb. 14, 2025

Related U.S. Application Data
(60) Provisional application No. 63/399,309, filed on Aug. 19, 2022.

(51) Int. Cl. H04W 72/25; H04W 36/00

(52) U.S. Cl. CPC H04W 72/25; H04W 36/00692

(57) ABSTRACT

One or more processors are configured to execute instructions that cause a first user equipment (UE) to perform operations in a network that supports multi-carrier carrier aggregation. The operations include: configuring a plurality of candidate carriers for communication with a second UE; determining the second UE as having a capability to perform a sidelink communication with the first UE; selecting one or more sidelink carriers from the plurality of candidate carriers; and communicating with the second UE using the one or more sidelink carriers.

### CROSS REFERENCE TO RELATED APPLICATIONS

This application claims priority to U.S. Provisional Ser. No. 63/399,309, filed Aug. 19, 2022, the content of which is incorporated hereby by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

Carrier Aggregation (CA) is a technique widely used in LTE communication for increasing data rate. With CA, multiple component carriers (CCs) are aggregated for communication between the network and a user equipment (UE). Recently, there have been studies about using CA in sidelink communications directly between multiple UEs in an NR network. Sidelink communication is a communication technique that enables UEs within close proximity to directly communicate without routing the traffic through the network. For the purposes of this disclosure, a UE that is initiating a sidelink communication with another UE is referred to as a transmission (TX) UE, and the UE receiving the sidelink communication is referred to as an RX UE.

### SUMMARY

In accordance with one aspect of the present disclosure, one or more processors are configured to execute instructions that cause a first user equipment (UE) to perform operations in a network that supports multi-carrier carrier aggregation. The operations include configuring a plurality of candidate carriers for communication with a second UE. The operations also include determining a capability of the second UE for performing a sidelink communication with the first UE. The operations include selecting one or more sidelink carriers from the plurality of candidate carriers. The operations also include communicating with the second UE using the one or more sidelink carriers.

In some implementations, the sidelink communication can include a broadcast communication or a groupcast communication. Selecting one or more sidelink carriers may include: determining a TX profile from a list of TX profiles; based on the TX profile, determining the second UE as not supporting multi-carrier CA for the sidelink communication; and selecting, based on the TX profile and from the plurality of candidate carriers, a single carrier as the one or more sidelink carriers. The TX profiles in the list can correspond to different layer 2 (L2) addresses or different services.

In some implementations, the operations can further include receiving, from the network, configuration information of an anchor channel; and communicating the one or more sidelink carriers to the second UE via a message in the anchor channel. Selecting one or more sidelink carriers can further include receiving, from the second UE, an indication of one or more RX carriers supported by the second UE; and determining that the one or more RX carriers are supported both by the first UE and by the second UE.

In some implementations, the sidelink communication can include a unicast communication. Selecting one or more sidelink carriers can further include: transmitting, to the second UE, a CA capability inquiry message; receiving, from the second UE, a CA capability response message; determining, based on the CA capability response message, that the second UE has or does not have capability to perform multi-carrier CA in the sidelink communication; determining, based on the CA capability response message and a capability of the first UE, a plurality of sidelink carriers (or a single carrier in the event that the second UE does not have capability to perform multi-carrier CA) supported both by the first UE and by the second UE; and communicating the plurality of sidelink carriers (or the single carrier) to the second UE via a message. Additionally or alternatively, selecting one or more sidelink carriers can further include: transmitting, to the second UE, a TX CA capability message; receiving, from the second UE, a RX CA capability message, wherein the RX CA capability message indicates that the second UE has capability to perform multi-carrier CA in the sidelink communication and indicates a plurality of sidelink carriers supported by the second UE; and transmitting, to the second UE, a message confirming that the first UE supports one or more of the plurality of sidelink carriers for performing multi-carrier CA in the sidelink communication, where the message can include a radio resource control (RRC) reconfiguration message transmitted in a PC5 interface.

In some implementations, communicating with the second UE using the one or more sidelink carriers can include: preconfiguring the first UE; and configuring the one or more sidelink carriers based on a system information block (SIB) or a dedicated RRC signal received from the network.

In accordance with one aspect of the present disclosure, a UE serving as a first UE performs a sidelink communication with a second UE in a network. The first UE includes a processor; and a transmitter. The processor supports a plurality of candidate carriers for multi-carrier CA; the processor determines a capability of the second UE for performing the sidelink communication with the first UE; the processor selects one or more sidelink carriers from the plurality of candidate carriers; and the transmitter communicates with the second UE using the one or more sidelink carriers.

In some implementations, the sidelink communication can include a broadcast communication or a groupcast communication. In selecting the one or more sidelink carriers, the processor determines a TX profile from a list of TX profiles. The processor determines, based on the TX profile, the second UE as not supporting multi-carrier CA for the sidelink communication. The processor selects, based on the TX profile and from the plurality of candidate carriers, a single carrier as the one or more sidelink carriers.

In some implementations, the UE can further include a receiver. The receiver receives, from the network, configuration information of an anchor channel. The transmitter communicates the one or more sidelink carriers to the second UE via a message in the anchor channel. In selecting the one or more sidelink carriers, the receiver receives, from the second UE, an indication of one or more RX carriers supported by the second UE; and the processor determines that the one or more RX carriers are supported both by the first UE and by the second UE.

In some implementations, the sidelink communication can include a unicast communication. The UE can further include a receiver. In selecting the one or more sidelink carriers, the transmitter transmits a CA capability inquiry message to the second UE. The receiver receives a CA capability response message from the second UE; the processor determines, based on the CA capability response message, that the second UE has capability to perform multi-carrier CA in the sidelink communication. The processor determines, based on the CA capability response message and a capability of the first UE, a plurality of sidelink carriers supported both by the first UE and by the second UE. The transmitter communicates the plurality of sidelink carriers to the second UE via a message.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example communication system, according to some implementations.

FIG. 2 illustrates example steps of selecting sidelink carries, according to some implementations.

FIG. 3 illustrates example steps of selecting sidelink carries, according to some implementations.

FIG. 4A illustrates example steps of selecting sidelink carries, according to some implementations.

FIG. 4B illustrates example steps of selecting sidelink carries, according to some implementations.

FIG. 5 illustrates a flowchart of an example method, according to some implementations.

FIG. 6 illustrates a UE, according to some implementations.

FIG. 7 illustrates an access node, according to some implementations.

### DETAILED DESCRIPTION

Recent releases of 3GPP, e.g., Release 18 (Rel-18), contemplate using CA for NR sidelink communications. When an RX UE has limited capability to receive sidelink communications with CA from a TX UE, the RX UE may not be able to properly communicate with the TX UE. Examples of an RX UE with limited capability include: a legacy (e.g., a Rel-17 or earlier) UE that supports only a single carrier, and a current (e.g., Rel-18) UE that supports only a subset of the aggregated carriers supported by the TX UE. In such scenarios, the TX UE and the RX UE need to align their respective choice of carrier(s) such that (i) the sidelink communication is properly performed and (ii) backward compatibility is ensured when a legacy RX UE communicates with a non-legacy TX UE.

This disclosure addresses the technical problem in some or all of the scenarios described above. Specifically, this disclosure describes one or more approaches to keep the TX UE informed of the sidelink capability of the RX UE so that the TX UE can properly select the carrier(s) used for sidelink communications. Some implementations apply to broadcast and/or groupcast sidelink communications, where the TX UE transmits information simultaneously to multiple RX UEs without specifying an individual destination address. Additionally or alternatively, some implementations apply to unicast communication, where the TX UE transmits information to one RX UE with a known destination address.

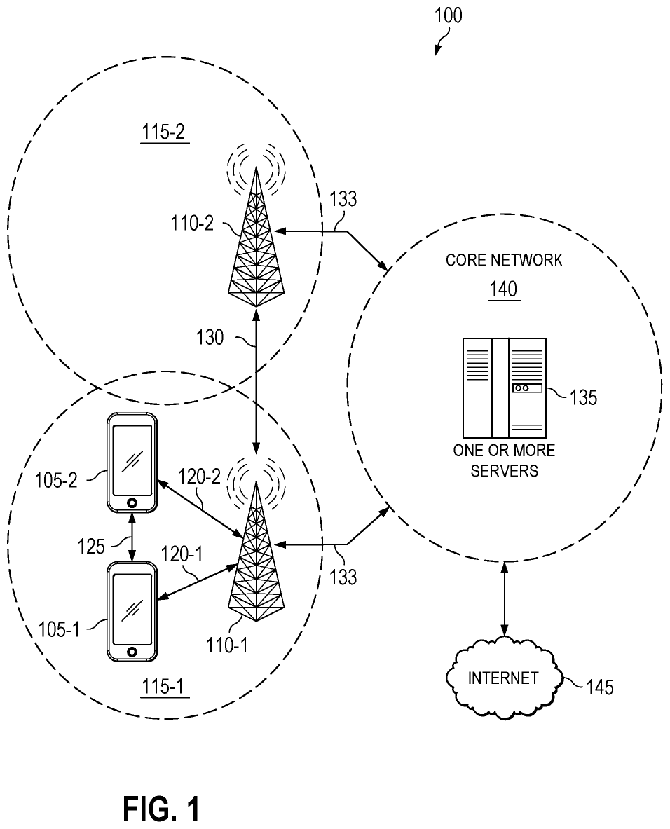

FIG. 1 illustrates an example communication system 100 that includes sidelink communications, according to some implementations. It is noted that the system of FIG. 1 is merely one example of a possible system, and that features of this disclosure may be implemented in other wireless communication systems.

The following description is provided for an example communication system that operates in conjunction with fifth generation (5G) networks as provided by 3GPP technical specifications. However, the example implementations are not limited in this regard and the described examples may apply to other networks that may benefit from the principles described herein, such as 3GPP Long Term Evolution (LTE) networks, Wi-Fi networks, and the like. Furthermore, other types of communication standards are possible, including future 3GPP systems (e.g., Sixth Generation (6G)). While aspects may be described herein using terminology commonly associated with 5G NR, aspects of the present disclosure can be applied to other systems, such as 3G, 4G, and/or systems subsequent to 5G (e.g., 6G).

Frequency bands for 5G NR may be separated into two different frequency ranges. Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1.

As shown, the communication system 100 includes a number of user devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

In some implementations, the UEs 105 can directly communicate with base stations 110 via links 120 (link 120-1 and link 120-2 are collectively referred to as “link 120” or “links 120”), which utilize a direct interface with the base stations referred to as a “Uu interface.” Each of the links 120 can represent one or more channels. The links 120 are illustrated as an air interface to enable communicative coupling, and can be consistent with cellular communication protocols, such as a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs (also called PC5-RRC signaling). The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

In some implementations, the UEs 105 may be configured with parameters for communicating via the Uu interface and/or the sidelink interface. In some examples, the UEs 105 may be “pre-configured” with some parameters. In these examples, the parameters may be hardwired into the UEs 105 or coded into spec. Additionally and/or alternatively, the UEs 105 may receive the parameters from the one or more of the base stations 110.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

In some implementations, one or more sidelink radio bearers may be established on the sidelink 125. The sidelink radio bearers can include signaling radio bearers (SL-SRB) and/or data radio bearers (SL-DRB).

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short-to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards. As used herein in the context of V2X systems, and as defined above, the term “user devices” may refer generally to devices that are associated with mobile actors or traffic participants in the V2X system, e.g., mobile (able-to-move) communication devices such as vehicles, pedestrian user equipment (PUE) devices, and road side units (RSUs).

In some implementations, UEs 105 may be physical hardware devices capable of running one or more applications, capable of accessing network services via one or more radio links 120 with a corresponding base station 110 (also referred to as a “serving” base station), and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs and vice versa.

In some implementations, the base stations 110 are capable of communicating with one another over a backhaul connection 130 and may communicate with the one or more servers 135 within the CN 140 over another backhaul connection 133. The backhaul connections can be wired and/or wireless connections.

In some implementations, the UEs 105 are configured to use a resource pool for sidelink communications. A sidelink resource pool defines the time-frequency resources used for sidelink communications, and may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In some implementations, an exceptional resource pool may be configured for the UEs 105, perhaps by the base stations 110. The exceptional resource pool includes resources that the UEs 105 can use in exceptional cases, such as Radio Link Failure (RLF). The exceptional resource pool may include resources selected based on a random allocation of resources.

In some implementations, a UE that is initiating a communication with another UE is referred to as a transmitter UE (TX UE), and the UE receiving the communication is referred to as a receiver UE (RX UE). For example, UE 105-1 may be a TX UE and UE 105-2 may be an RX UE. Although FIG. 1 illustrates a single TX UE communicating with a single RX UE, a TX UE may communicate with more than one RX UE via sidelink.

In some implementations, a TX UE that is initiating sidelink communication may determine the available resources (e.g., sidelink resources) and may select a subset of these resources to communicate with an RX UE based on a resource allocation scheme. Example resource allocation schemes include Mode 1 and Mode 2 resource allocation schemes. In Mode 1 resource allocation scheme (referred to as “Mode 1”), the resources are allocated by a network node for in-coverage UEs. In Mode 2 resource allocation scheme (referred to as “Mode 2”), the TX UE selects the sidelink resources (e.g., sidelink transmission resources).

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In the communication system 100, UE 105-1 may be a TX UE and UE 105-2 may be an RX UE. Further, although FIG. 1 illustrates a single TX UE communicating with a single RX UE, a TX UE may communicate with more than one RX UE via sidelink.

In some implementations, a TX UE that is initiating sidelink communication may determine the available resources (e.g., sidelink resources) and may select a subset of these resources to communicate with an RX UE based on a resource allocation scheme. Example resource allocation schemes include Mode 1 and Mode 2 resource allocation schemes. In Mode 1 resource allocation scheme (referred to as “Mode 1”), the resources are allocated by a network node for in-coverage UEs. In Mode 2 resource allocation scheme (referred to as “Mode 2”), the TX UE selects the sidelink resources (e.g., sidelink transmission resources).

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

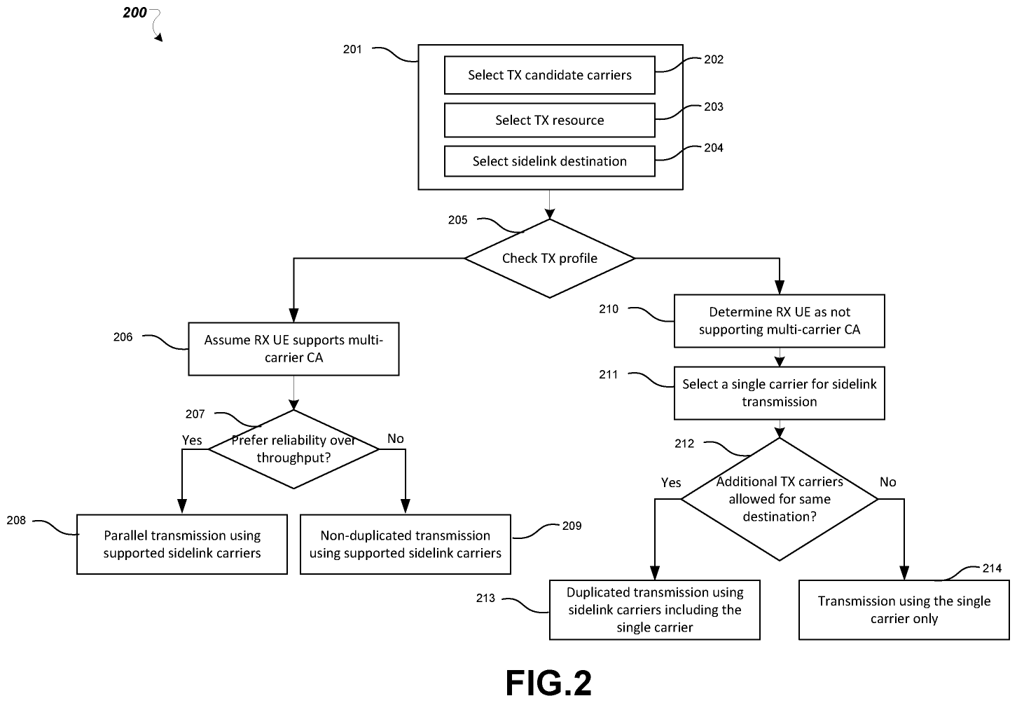

FIG. 2 illustrates an example method 200 for selecting sidelink carriers, according to some implementations. The method 200 can be implemented by the TX UE 105-1 in the communication system 100 illustrated in FIG. 1. The following description of the method 200 assumes that the sidelink communication is performed between the TX UE 105-1 and the RX UE 105-2.

In some implementations, the method 200 uses a list of TX profiles to help the TX UE 105-1 determine whether limited capability of the RX UE 105-2 needs to be considered when performing sidelink CA. The list of TX profiles may be configured to the TX UE 105-1 prior to establishing the sidelink communication. In some implementations, the method 200 can be applied to groupcast and/or broadcast communications.

At 201, the TX UE 105-1 configures a plurality of candidate carriers that can be used for sidelink communication with the RX UE 105-2. The plurality of candidate carriers can be provided by RRC configuration from a Uu interface, or can be provided to the TX UE 105-1 and then passed down the TX UE 105-1's upper layers. In some implementations, 201 can be further broken down into 202-204. At 202, the TX UE 105-1 selects, from a list of carriers it supports, a plurality of candidate carriers for the sidelink communication. At 203, the TX UE 105-1 selects TX resources to schedule the sidelink communication. At 204, the TX UE 105-1 selects broadcast or groupcast destinations for the sidelink communication.

At 205, the TX UE 105-1 checks a list of TX profiles to determine whether a limited capability of the RX UE 105-2 is to be considered when performing the sidelink communication. The TX profiles can be structured to correspond to different Layer 2 (L2) addresses or different services for which the sidelink traffic is transmitted. Each TX profile in the list can be accompanied by an indication of whether NR sidelink CA applies to the L2 address or the service. This can be equivalent to an indication of the release of the intended receiver (RX UE 105-2 in this example) of a particular service. In other words, the TX profile tells the TX UE 105-1 the working assumption of RX UE 105-2, e.g., whether the RX UE 105-2 can be assumed as a current Rel-18 UE or a legacy UE. Based on the assumption, the TX UE 105-1 designates (e.g., determines) the RX UE 105-2 as supporting multi-carrier CA or not for the sidelink communication. With the designation, the TX UE 105-1 may or may not take steps to confirm the assumption. That is, the TX UE 105-1 may communicate with the RX UE 105-2 to confirm if the assumption is true, or, alternatively, proceed with performing the communication based on the assumption without confirming it with the RX UE 105-2.

As an example, the list of TX profiles can be represented as SL-TxProfileList-r18::=SEQUENCE (SIZE (1 . . . 256)) OF SL-TxProfile-r18. According to this representation, the list “SL-TxProfileList-r18” of TX profiles is configured for a Rel-18 TX UE to perform sidelink communication and a total of 256 TX profiles SL-TxProfile-r18 are included in the list. Each of the 256 TX profiles can correspond to an L2 address of a destination RX UE of the sidelink communication RX UE or a service delivered in the sidelink traffic to the destination RX UE.

In some implementations, within the example list SL-TxProfileList-r18, each TX profile SL-TxProfile-r18 can be represented as SL-TxProfile-r18=ENUMERATED{Rel-18, Rel-17orOlder, spare6, spare5, spare4, spare3, spare2, spare1, . . .}. According to this representation, each TX profile SL-TxProfile-r18 includes: (a) a field (e.g., one or more bits) “Rel-18” indicating whether the L2 address (or the service) corresponding to the TX profile is associated with a current Rel-18 UE that has CA capability, and (b) a field “Rel-17orOlder” indicating whether the L2 address (or the service) is associated with a legacy Rel-17 or older UE that does not have CA capability. Alternatively, each TX profile SL-TxProfile-r18 can be represented as SL-TxProfile-r18=ENUMERATED{carrierAggregated, singleCarrier, spare6, spare5, spare4, spare3, spare2, spare1, . . .}. According to this representation, each TX profile SL-TxProfile-r18 includes a field (c) “carrierAggregated” indicating that a UE at the L2 address (or the service) is intended to have CA capability, and (d) a field “singleCarrier” indicating that a UE at the L2 address (or the service) is intended to support a single carrier only without being required to support CA. By reading fields (a) and (b) or fields (c) and (d), the TX UE 105-1 in this example can determine whether CA with multiple carriers can be used in the sidelink communication with the RX UE 105-2.

In some implementations, within the example list SL-TxProfileList-r18, each TX profile SL-TxProfile-r18 can be represented as SL-TxProfile-r18=SEQUENCE{freq1, freq2, freq3, . . .}. According to this representation, each TX profile SL-TxProfile-r18 includes a set of one or more carrier frequencies to be used by the L2 address (or the service). If TX profile contains a single carrier frequency in the SEQUENCE, then the TX profile indicates the L2 address (or the service) is associated with a legacy UE for which only a single carrier is allowed (i.e., sidelink SA is not supported). Alternatively, if TX profile contains multiple carrier frequencies, then the TX profile indicates that the sidelink communication to the corresponding L2 addresses (or the services) is intended to reach UE(s) with CA capability.

The TX profiles described above are only a limited number of examples, while many other forms are available to implement the TX profile. Furthermore, the TX profile can possibly be formed using a combination of the above examples. For instance, the TX profile can possibly be formed to include both a release indication, such as ENUMERATED{Rel-18, Rel-17orOlder, spare6, spare5, spare4, spare3, spare2, spare1, . . .}, and a set of supported carrier frequencies, such as SEQUENCE{freq1, freq2, freq3, . . .}.

If the TX profile indicates that the L2 address (or the service) has CA capability, this may indicate that the RX UE 105-2 is intended to be a Rel-18 UE. For example, this may indicate that the sidelink service is intended to be performed with a Rel-18 UE or that UE(s) listening to this L2 address are all Rel-18 UE(s). Thus, at 206, the TX UE 105-1 designates the RX UE 105-2 as supporting sidelink CA and further assumes that the RX UE 105-2 supports all sidelink carriers selected by the TX UE 105-1. Thus, the TX UE 105-1 can perform the sidelink communication using the supported sidelink carriers configured at 201. In some implementations, the TX UE 105-1 can further determine at 207, based on a Quality-of-Service (QoS) profile, whether the sidelink communication prioritizes communication reliability (e.g., quality) or throughput (e.g., data rate). If high reliability is preferred over high throughput, then the TX UE 105-1, at 208, can use the supported sidelink carriers to perform parallel transmission of the same data. If high throughput is preferred over high reliability, then the TX UE 105-1, at 209, can use the supported sidelink carriers to perform non-duplicated transmission to increase the speed of data transmission.

If the TX profile indicates that the L2 address (or the service) does not have CA capability, this may indicate that the RX UE 105-2 can be a legacy UE. Thus, at 210, the TX UE 105-1 designates the RX UE 105-2 as not supporting sidelink CA. As a result, at 211, the TX UE 105-1 selects a single carrier to perform the sidelink communication with the RX UE 105-2. In some implementations, the TX UE 105-1 can further determine at 212 whether the destination allows transmission on additional carriers even if the RX UE 105-2 does not have CA capability. If the answer is “Yes,” then the TX UE 105-1, at 213, uses the supported sidelink carriers, including the single carrier selected for the RX UE 105-2, to perform duplicated transmission. Such duplicated transmission over multiple carriers can include transmission of Media Access Control (MAC) Protocol Data Unit (PDU). Conversely, if the answer is “No,” then the TX UE 105-1, at 214, uses the single carrier only to perform the sidelink communication with the RX UE 105-2.

According to the description above, the method 200 allows TX UEs to determine the CA capability of RX UEs based on the nature (e.g., destination or service) of the sidelink communication. These operations improve the reliability of the broadcast or groupcast communication without requiring extra communication between TX UEs and RX UEs.

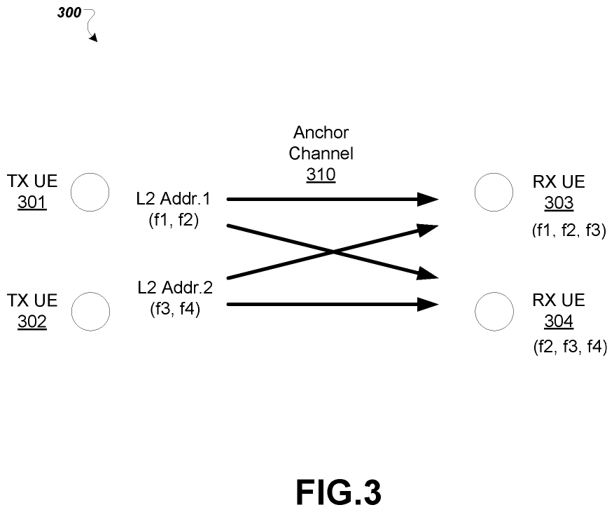

FIG. 3 illustrates a method 300 with example steps of selecting sidelink carries, according to some implementations. For the purpose of illustration, FIG. 3 shows two TX UEs 301 and 302, both of which can be the same as the TX UE 105-1 illustrated in FIG. 1, and two RX UEs 303 and 304, both of which can be the same as the RX UE 105-2 illustrated in FIG. 1. Nevertheless, the method 300 does not necessarily require two TX UEs and two RX UEs. Some implementations can include only one TX UE in communication with one or more RX UEs. The method 300 can be applied to groupcast and/or broadcast communications.

In some implementations, the method 300 applies to scenarios where the RX UEs 303 and 304 are Rel-18 UEs with limited CA capability in sidelink communication. In these scenarios, although the TX UEs 301 and 302 have full capability to perform CA using multiple carriers in sidelink communication, the RX UEs 303 and 304 only support a subset of the sidelink carriers available for CA. Given their limited capability for CA, the RX UEs 303 and 304 do not need to listen to all available carriers. Rather, the RX UEs 303 and 304 only listen to the carriers that they support.

Similar to the method 200 of FIG. 2, the method 300 can begin with the TX UEs 301 and 302 configuring a plurality of candidate carriers for sidelink communication. These steps and the description thereof are omitted for brevity.

Once the TX UEs 301 and 302 select a plurality of sidelink carriers, the TX UEs 301 and 302 use an anchor channel 310 to announce their respective choices of sidelink carriers for CA to the RX UEs 303 and 304. In some implementations, the anchor channel 310 can be configured by a network such as the CN 140 in FIG. 1. In the announcement, each of the TX UEs 301 and 302 can include its L2 address and its choice of sidelink carriers. Upon receiving the announcements, each of the RX UEs 303 and 304 can determine one or more sidelink carriers that are supported both by the announcing TX UE and the RX UE itself. Each of the RX UEs 303 and 304 can also determine the set of carriers it needs to monitor simultaneously based on each RX UE's limited capability. The one or more sidelink carriers determined by the RX UEs 303 and 304 can then be communicated to the corresponding TX UE for sidelink communication. The above-described use of the anchor channel 310 is not limited to groupcast and broadcast communications. For example, the anchor channel 310 can be similarly used in unicast communications for TX UEs to announce their respective choices of sidelink carriers.

In the example of FIG. 3, the RX UE 303 supports carriers f1, f2, and f3, and the RX UE 304 supports carriers f2, f3, and f4. On the other side, the TX UE 301 selects carriers f1 and f2, and the TX UE 302 selects carriers f3 and f4, for sidelink communication. According to the method 300, the TX UE 301 announces, via the anchor channel 310, its choice of carriers f1 and f2, along with its L2 address, “Addr.1.” Similarly, the TX UE 302 announces, via the anchor channel 310, its choice of carriers f3 and f4, along with its L2 address,“Addr.2.” The announcement can further indicate that the selected carriers are for duplicated or non-duplicated transmissions. In some implementations, the announcement can be in the form of a radio resource control (RRC) message.

Upon receiving the announcement from the TX UE 301, the RX UE 303 determines that carriers f1 and f2 are supported both by the TX UE 301 and the RX UE 303 itself. Thus, the RX UE 303 can monitor only carriers f1 and f2 for sidelink communication initiated by the TX UE 301 at Addr.1. In some implementations, the RX UE 303 can further inform the TX UE 301 that carriers f1 and f2 are supported by both the RX UE 303 and the TX UE 301.

Similarly, upon receiving the announcement from the TX UE 302, the RX UE 303 determines that carrier f3 is supported both by the TX UE 302 and the RX UE 303 itself. Thus, the RX UE 303 can monitor only carrier f3 for sidelink communication initiated by the TX UE 302 at Addr.2. In some implementations, the RX UE 303 can further inform the TX UE 302 that carrier f3 is supported by both the RX UE 303 and the TX UE 301.

The operations of the RX UE 304 are similar to those of the RX UE 303 described above. With these operations, the RX UE 304 can monitor only carrier f2 for sidelink communication initiated by the TX UE 301, and can monitor only carriers f3 and f4 for sidelink communication initiated by the TX UE 302.

According to the description above, the method 300 allows the RX UEs with limited capability to be informed of the sidelink carriers that the TX UEs will use. This not only improves reliability of the broadcast or groupcast communication but can also reduce the power consumption on the RX side because the RX UEs do not need to monitor all supported carriers.

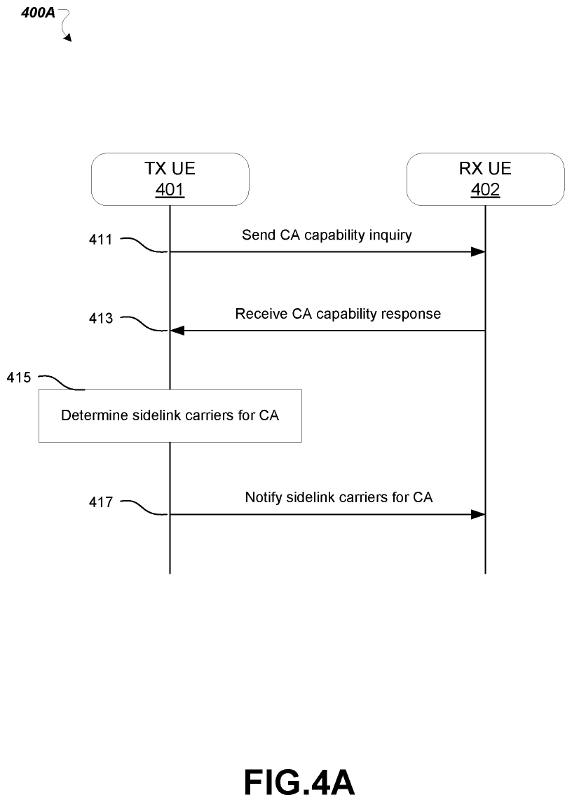

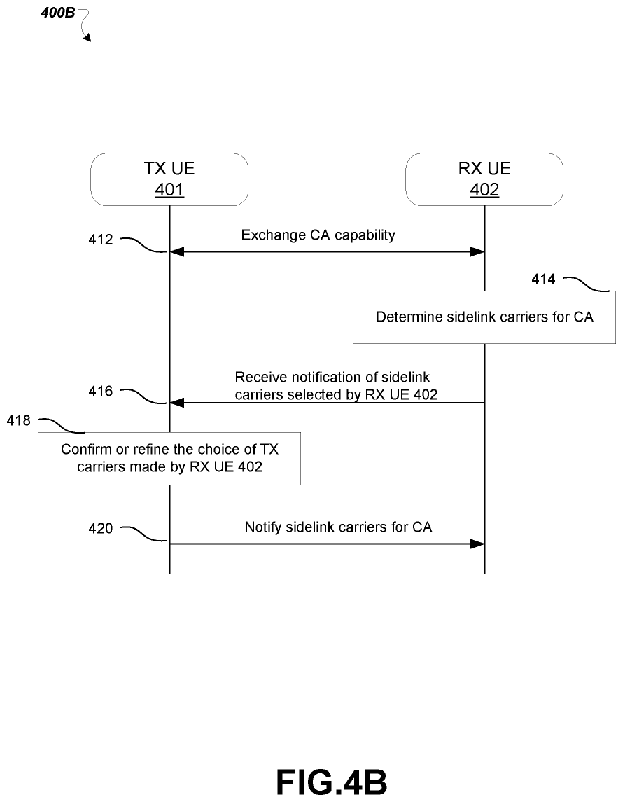

FIGS. 4A and 4B illustrate example methods 400A and 400B, respectively, for selecting sidelink carries, according to some implementations. The TX UE 401 and the RX UE 402 can be the same as the TX UE 105-1 and the RX UE 105-2, respectively, in the communication system 100 of FIG. 1. In some implementations, the methods 400A and 400B can be applied to sidelink unicast communications.

In both methods 400A and 400B, the TX UE 401 and the RX UE 402 may or may not have the same capability in performing CA in sidelink communication. For example, the maximum number of carriers that can be supported may be different between the TX UE 401 and the RX UE 402; or the TX UE 401 and the RX UE 402, due to their hardware, may be unable to support both one or more component carriers in one or more bands. Thus, in both example methods, the TX UE 401 and the RX UE 402 exchange their respective capability of CA and negotiate what carriers to use for the sidelink communication. The method 400A can be regarded as “TX-centric,” where the determination of sidelink carriers is primarily made by the TX UE 401, while the method 400B can be regarded as “RX-centric,” where the determination of sidelink carriers is primarily made by the RX UE 402.

Similar to the method 200 illustrated in FIG. 2, the methods 400A and 400B can begin with the TX UE 401 configuring a plurality of candidate carriers for sidelink communication. These steps and the description thereof are omitted for brevity.

Turning to the method 400A, at 411, the TX UE 401 sends an inquiry message, such as “CapabilityEnquirySidelink,” to the RX UE 402 to inquire about the CA capability of the RX UE 402.

At 413, the RX UE 402 responds to the inquiry message by sending a response message, such as “CapabilityInformationSidelink,” to the TX UE 401. The response message informs the TX UE 401 whether the RX UE 402 supports CA in sidelink communication and, if so, which sidelink carriers the RX UE 402 supports.

At 415, the TX UE 401 decides, based on the response message, whether CA can be performed in the sidelink communication, and, if so, which sidelink carriers are supported by both the TX UE 401 and the RX UE 402. In some implementations, the response message indicates that the RX UE 402 does not have capability to perform multi-carrier CA. In these implementations, the TX UE 401 decides that only a single carrier can be used for the sidelink communication.

At 417, upon selecting the sidelink carriers to use in the sidelink communication, the TX UE 401 notifies the RX UE 402 of the selected sidelink carriers for CA operation. In implementations where the RX UE 402 does not have capability to perform multi-carrier CA, the TX UE 401 selects only a single carrier. The notification can be sent from the TX UE 401 to the RX UE 402 via a PC5 interface and can be formed as a PC5-RRC reconfiguration message. In some examples, the notification can further indicate whether the sidelink communication will be performed in duplication, such as CA packet data convergence protocol (PDCP) duplication. Upon receiving the notification, the RX UE 402 can determine the sidelink carriers to be used in the upcoming sidelink communication and can start monitoring these sidelink carriers.

Turning to the method 400B, at 412, the TX UE 401 and the RX UE 402 exchange their respective CA capability information. That is, the TX UE 401 informs the RX UE 402 of the sidelink carriers supported by the TX UE 401. Further, the RX UE 402 informs the TX UE 401 whether the RX UE 402 supports CA in sidelink communication and, if so, which sidelink carriers the RX UE 402 supports. The capability exchange can be via messages such as “CapabilityInformationSidelink.”

At 414, the RX UE 402 determines which sidelink carriers, if any, are supported by both the TX UE 401 and the RX UE 402. The RX UE 402 then selects these carriers for carrier aggregation used in the sidelink communication between those two UEs and notifies the TX UE 401 of the selection.

At 416, the TX UE 401 receives a notification from the RX UE 402 indicative of the sidelink carriers of CA supported by both the TX UE 401 and the RX UE 402. The notification can be via a message such as “UEAssistanceInformation.” Alternatively or additionally, the notification is only indicative of some or all sidelink carriers supported by the RX UE 402 regardless of whether the indicated sidelink carriers are also supported by the TX UE 401. In these scenarios, it is up to the TX UE 401 to decide, based on its own capability, which of the indicated sidelink carriers are supported by both UEs.

At 418, the TX UE 401 confirms that some or all the sidelink carriers notified by the RX UE 402 will be used in the sidelink communication. In some examples, before confirming, the TX UE 401 can refine the choice made by the RX UE 402 by, e.g., repeating 412-416.

At 420, after both the TX UE 401 and the RX UE 402 agree on the choice of sidelink carriers, the TX UE 401 sends a notification indicative of the finalized sidelink carriers used for CA. The notification can be sent via a PC5 interface and can be formed as a PC5-RRC reconfiguration message. In some implementations, the notification can further indicate whether the sidelink communication will be performed in duplication. Upon receiving the notification, the RX UE 402 can determine the sidelink carriers to be used in the upcoming sidelink communication and can start monitoring these sidelink carriers.

The methods 400A and 400B, which can be regarded as negotiation processes, provide effective mechanisms for the TX UE 401 and the RX UE 402 to obtain knowledge of the other's capability of performing CA in sidelink communication. These effective mechanisms can improve communication reliability in unicast communications.

In the implementations described above with reference to FIGS. 2-4B, the TX UE needs to be configured by a network, such as the CN 140 in FIG. 1, before performing the sidelink communication using the sidelink carriers. The configuration can be made via an SIB, a dedicated RRC message, and/or a pre-configuration. Using the configuration, the TX UE configures a set of common TX carriers as candidate sidelink carriers using CA for communicating with all available RX UEs in the proximity. In some examples, a subset of carriers among the candidate sidelink carriers can be configured for each L2 address, especially for L2 addresses associated with groupcast or broadcast sidelink communications. For L2 addresses corresponding to a service supported by Rel-16/Rel-17 NR sidelink UEs, the configuration provides a single carrier to be potentially used by the TX UE. In some examples where one or more L2 addresses are not explicitly configured with carrier subsets, the configuration can provide a default set of TX carriers to be used by the TX UE for communicating to these L2 addresses.

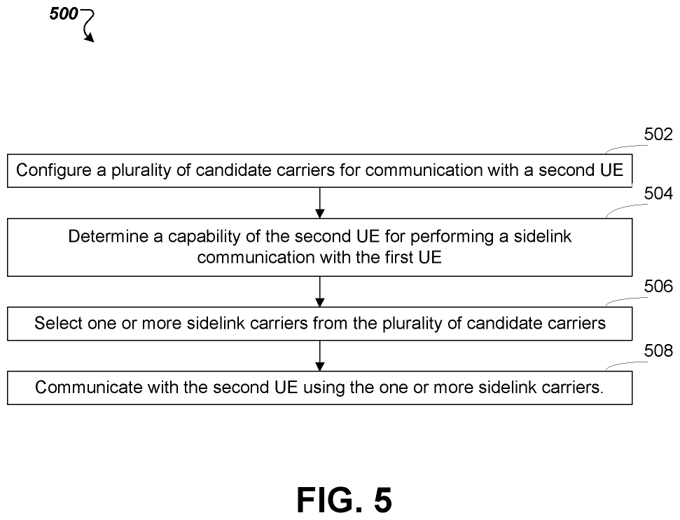

FIG. 5 illustrates a flowchart of an example method 500, according to some implementations. For clarity of presentation, the description that follows generally describes the method 500 in the context of the other figures in this description. For example, the method 500 can be performed by the TX UE 105-1 of FIG. 1, the TX UEs 301 or 302 of FIG. 3, or the TX UE 401 of FIGS. 4A and 4B. It will be understood that the method 500 can be performed, for example, by any suitable system, environment, software, hardware, or a combination of systems, environments, software, and hardware, as appropriate. In some implementations, various steps of method 500 can be run in parallel, in combination, in loops, or in any order.

At 502, the method 500 involves configuring a plurality of candidate carriers for communication with a second UE, such as the RX UE 105-2 of FIG. 1, the RX UEs 303 or 304 of FIG. 3, or the RX UE 402 of FIGS. 4A and 4B.

At 504, the method 500 involves determining a capability of the second UE for performing a sidelink communication with the first UE. The capability can be a limited capability or an unlimited capability.

At 506, the method 500 involves selecting one or more sidelink carriers from the plurality of candidate carriers.

At 508, the method 500 involves communicating with the second UE using the one or more sidelink carriers.

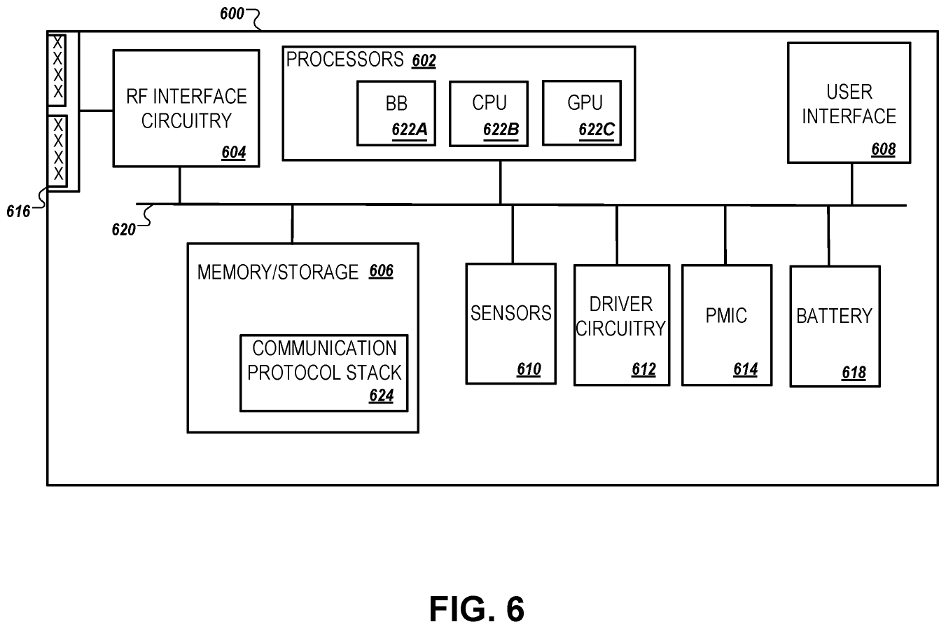

FIG. 6 illustrates a UE 600, according to some implementations. The UE 600 may be similar to and substantially interchangeable with any of the UEs described in FIGS. 1-5.

The UE 600 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 600 may include processors 602, RF interface circuitry 604, memory/storage 606, user interface 608, sensors 610, driver circuitry 612, power management integrated circuit (PMIC) 614, one or more antennas 616, and battery 618. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 620, which may represent any type of interface, input/output, bus (local, system, or expansion), transmission line, trace, optical connection, etc. that allows various circuit components (on common or different chips or chipsets) to interact with one another.

The processors 602 may include processor circuitry such as, for example, baseband processor circuitry (BB) 622A, central processor unit circuitry (CPU) 622B, and graphics processor unit circuitry (GPU) 622C. The processors 602 may include any type of circuitry or processor circuitry that executes or otherwise operates computer-executable instructions, such as program code, software modules, or functional processes from memory/storage 606 to cause the UE 600 to perform operations as described herein.

In some implementations, the baseband processor circuitry 622A may access a communication protocol stack 624 in the memory/storage 606 to communicate over a 3GPP compatible network. In general, the baseband processor circuitry 622A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 604. The baseband processor circuitry 622A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 606 may include one or more non-transitory, computer-readable media that includes instructions (for example, communication protocol stack 624) that may be executed by one or more of the processors 602 to cause the UE 600 to perform various operations described herein. The memory/storage 606 include any type of volatile or non-volatile memory that may be distributed throughout the UE 600. In some implementations, some of the memory/storage 606 may be located on the processors 602 themselves (for example, L1 and L2 cache), while other memory/storage 606 is external to the processors 602 but accessible thereto via a memory interface. The memory/storage 606 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 604 may include transceiver circuitry and radio frequency front module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via one or more antennas 616 and proceed to filter and amplify (with a low-noise amplifier) the signal. The signal may be provided to a receiver of the transceiver that downconverts the RF signal into a baseband signal that is provided to the baseband processor of the processors 602.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 616. In various implementations, the RF interface circuitry 604 may be configured to transmit/receive signals in a manner compatible with NR access technologies.

The antenna 616 may include antenna elements to convert electrical signals into radio waves to travel through the air and to convert received radio waves into electrical signals. The antenna elements may be arranged into one or more antenna panels. The antenna 616 may have antenna panels that are omnidirectional, directional, or a combination thereof to enable beamforming and multiple input, multiple output communications. The antenna 616 may include microstrip antennas, printed antennas fabricated on the surface of one or more printed circuit boards, patch antennas, phased array antennas, etc. The antenna 616 may have one or more panels designed for specific frequency bands including bands in FR1 or FR2.

The user interface 608 includes various input/output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various input/output (I/O) devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensors 610 and control and allow access to sensors 610, drivers to obtain actuator positions of electro-mechanic components or control and allow access to the electro-mechanic components, a camera driver to control and allow access to an embedded image capture device, audio drivers to control and allow access to one or more audio devices.

The PMIC 614 may manage power provided to various components of the UE 600. In particular, with respect to the processors 602, the PMIC 614 may control power-source selection, voltage scaling, battery charging, or DC-to-DC conversion.

In some implementations, the PMIC 614 may control, or otherwise be part of, various power saving mechanisms of the UE 600. A battery 618 may power the UE 600, although in some examples the UE 600 may be mounted deployed in a fixed location, and may have a power supply coupled to an electrical grid. The battery 618 may be a lithium ion battery, a metal-air battery, such as a zinc-air battery, an aluminum-air battery, a lithium-air battery, and the like. In some implementations, such as in vehicle-based applications, the battery 618 may be a typical lead-acid automotive battery.

In various implementations, aspects of the processor 602, memory/storage 606, and RF interface circuitry 604 may be integrated in various ways to implement the operations described herein. For example, the processor 602 may be configured to determine the CA capability of itself or another UE and select and configure sidelink carriers, the memory/storage 606 may be configured to store TX profiles or other information needed by the processor 602 to select sidelink carriers, and the RF interface circuitry 604 may be configured to transmit and receive wireless signals with another UE or the network.

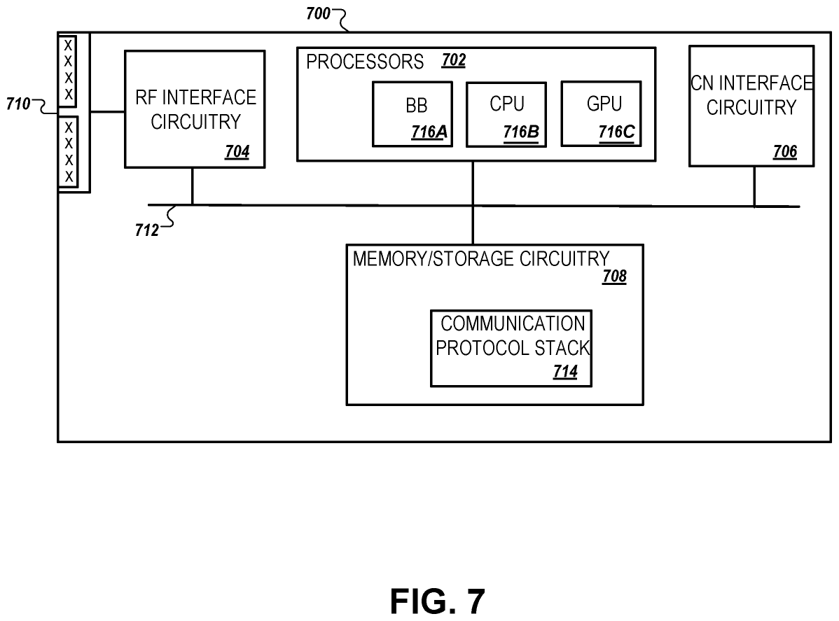

FIG. 7 illustrates an access node 700 (e.g., a base station or gNB), according to some implementations. The access node 700 may be similar to and substantially interchangeable with the base station 110 of FIG. 1. The access node 700 may include processors 702, RF interface circuitry 704, CN interface circuitry 706, memory/storage circuitry 708, and one or more antennas 710.

The components of the access node 700 may be coupled with various other components over one or more interconnects 712. The processors 702, RF interface circuitry 704, memory/storage circuitry 708 (including communication protocol stack 714), one or more antennas 710, and interconnects 712 may be similar to like-named elements shown and described with respect to FIG. 6. For example, the processors 702 may include processor circuitry such as, for example, baseband processor circuitry (BB) 716A, central processor unit circuitry (CPU) 716B, and graphics processor unit circuitry (GPU) 716C.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various implementations, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 700 may be implemented as one or more software entities running on server computers as part of a virtual network, which may be referred to as a CRAN and/or a virtual baseband unit pool (vBBUP). In V2X scenarios, the access node 700 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes one or more processors configured to execute instructions that cause a first user equipment (UE) to perform operations in a network that supports multi-carrier carrier aggregation (CA), the operations including: configuring a plurality of candidate carriers for communication with a second UE; determining a capability of the second UE for performing a sidelink communication with the first UE; selecting one or more sidelink carriers from the plurality of candidate carriers based on the determining; and communicating with the second UE using the one or more sidelink carriers.

Example 2 includes the one or more processors of example 1, wherein the sidelink communication includes a broadcast communication or a groupcast communication.

Example 3 includes the one or more processors of example 2, wherein selecting one or more sidelink carriers includes: determining a transmission (TX) profile from a list of TX profiles; based on the TX profile, determining the second UE as not supporting multi-carrier CA for the sidelink communication; and selecting, based on the TX profile and from the plurality of candidate carriers, a single carrier as the one or more sidelink carriers.

Example 4 includes the one or more processors of example 3, wherein the TX profiles in the list correspond to different layer 2 (L2) addresses or different services.

Example 5 includes the one or more processors of example 1, the operations further including: receiving, from the network, configuration information of an anchor channel; and communicating the one or more sidelink carriers to the second UE via a message in the anchor channel.

Example 6 includes the one or more processors of example 5, wherein selecting one or more sidelink carriers includes: receiving, from the second UE, an indication of one or more reception (RX) carriers supported by the second UE; and determining that the one or more RX carriers are supported both by the first UE and by the second UE.

Example 7 includes the one or more processors of example 1, wherein the sidelink communication includes a unicast communication.

Example 8 includes the one or more processors of example 7, wherein selecting one or more sidelink carriers includes: transmitting, to the second UE, a CA capability inquiry message; receiving, from the second UE, a CA capability response message; determining, based on the CA capability response message, that the second UE has capability to perform multi-carrier CA in the sidelink communication; determining, based on the CA capability response message and a capability of the first UE, a plurality of sidelink carriers supported both by the first UE and by the second UE; and communicating the plurality of sidelink carriers to the second UE via a message.

Example 9 includes the one or more processors of example 8, the operations further including: determining, based on the CA capability response message, that the second UE does not have capability to perform multi-carrier CA in the sidelink communication; and selecting a single carrier as the one or more sidelink carriers.

Example 10 includes the one or more processors of example 7, wherein selecting one or more sidelink carriers includes: transmitting, to the second UE, a transmission (TX) CA capability message; receiving, from the second UE, a reception (RX) CA capability message, wherein the RX CA capability message indicates that the second UE has capability to perform multi-carrier CA in the sidelink communication and indicates a plurality of sidelink carriers supported by the second UE; and transmitting, to the second UE, a message confirming that the first UE supports one or more of the plurality of sidelink carriers for performing multi-carrier CA in the sidelink communication.

Example 11 includes the one or more processors of example 10, wherein the plurality of sidelink carriers supported by the second UE include one or more sidelink carriers supported by the first UE.

Example 12 includes the one or more processors of example 10, wherein the message includes a radio resource control (RRC) reconfiguration message transmitted in a PC5 interface.

Example 13 includes the one or more processors of example 1, wherein communicating with the second UE using the one or more sidelink carriers includes: preconfiguring the first UE; and configuring the one or more sidelink carriers based on a system information block (SIB) or a dedicated radio resource control (RRC) signal received from the network.

Example 14 includes a user equipment (UE) serving as a first UE in a sidelink communication with a second UE in a network, the first UE including: a processor; and a transmitter, wherein the processor is configured to cause the UE to: support a plurality of candidate carriers for multi-carrier carrier aggregation (CA); determine a capability of the second UE for performing the sidelink communication with the first UE; and select one or more sidelink carriers from the plurality of candidate carriers based on the determining, and wherein the transmitter is configured to communicate with the second UE using the one or more sidelink carriers.

Example 15 includes the UE of example 14, wherein the sidelink communication includes a broadcast communication or a groupcast communication.

Example 16 includes the UE of example 15, wherein in selecting the one or more sidelink carriers: the processor is configured to: determine a transmission (TX) profile from a list of TX profiles; based on the TX profile, determine the second UE as not supporting multi-carrier CA for the sidelink communication; and select, based on the TX profile and from the plurality of candidate carriers, a single carrier as the one or more sidelink carriers.

Example 17 includes the UE of example 15, wherein the TX profiles in the list correspond to different layer 2 (L2) addresses or different services.

Example 18 includes the UE of example 14, further including a receiver. In selecting the one or more sidelink carriers: the receiver is configured to receive, from the network, configuration information of an anchor channel; and the transmitter is configured to communicate the one or more sidelink carriers to the second UE via a message in the anchor channel.

Example 19 includes the UE of example 14, wherein the sidelink communication includes a unicast communication.

Example 20 includes the UE of example 19, further including a receiver. In selecting the one or more sidelink carriers: the transmitter is configured to transmit a CA capability inquiry message to the second UE; the receiver is configured to receive a CA capability response message from the second UE; the processor is configured to determine, based on the CA capability response message, that the second UE has capability to perform multi-carrier CA in the sidelink communication; the processor is configured to determine, based on the CA capability response message and a capability of the first UE, a plurality of sidelink carriers supported both by the first UE and by the second UE; and the transmitter is configured to communicate the plurality of sidelink carriers to the second UE via a message.

Example 21 includes the UE of example 20, wherein the processor is configured to: determine, based on the CA capability response message, that the second UE does not have capability to perform multi-carrier CA in the sidelink communication; and select a single carrier as the one or more sidelink carriers.

Example 22 includes the UE of example 21, further including a receiver. In selecting the one or more sidelink carriers: the transmitter is configured to transmit, to the second UE, a transmission (TX) CA capability message; the receiver is configured to receive, from the second UE, a reception (RX) CA capability message, wherein the RX CA capability message indicates that the second UE has capability to perform multi-carrier CA in the sidelink communication and indicates a plurality of sidelink carriers supported by the first UE; and the transmitter is configured to transmit, to the second UE, a message confirming that the first UE supports one or more of the plurality of sidelink carriers for performing multi-carrier CA in the sidelink communication Example 23 includes the UE of example 22, wherein the plurality of sidelink carriers supported by the second UE include one or more sidelink carriers supported by the first UE.

Example 24 includes the UE of example 22, wherein the message includes a radio resource control (RRC) reconfiguration message transmitted in a PC5 interface.

Example 25 includes the UE of example 14, wherein: the processor preconfigures the first UE; and the processor configures the one or more sidelink carriers based on a system information block (SIB) or a dedicated radio resource control (RRC) signal received from the network.

Example 26 may include one or more non-transitory computer-readable media including instructions to cause an electronic device, upon execution of the instructions by one or more processors of the electronic device, to perform one or more elements of a method described in or related to any of examples 1-25, or any other method or process described herein.

Example 27 may include an apparatus including logic, modules, or circuitry to perform one or more elements of a method described in or related to any of examples 1-25, or any other method or process described herein.

Example 28 may include a method, technique, or process as described in or related to any of examples 1-25, or portions or parts thereof.

Example 29 may include an apparatus including: one or more processors and one or more computer-readable media including instructions that, when executed by the one or more processors, cause the one or more processors to perform the method, techniques, or process as described in or related to any of examples 1-25, or portions thereof.

Example 30 may include a computer program including instructions, wherein execution of the program by a processing element is to cause the processing element to carry out the method, techniques, or process as described in or related to any of examples 1-25, or portions thereof. The operations or actions performed by the instructions executed by the processing element can include the operations of any one of examples 1-25.

Example 31 may include a method of communicating in a wireless network as shown and described herein.

Example 32 may include a system for providing wireless communication as shown and described herein. The operations or actions performed by the system can include the methods of any one of examples 1-25.

Example 33 may include a device for providing wireless communication as shown and described herein. The operations or actions performed by the device can include the methods of any one of examples 1-25.

The previously-described examples 1-25 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-20. (canceled)

21. One or more processors configured to, when executing instructions stored in a memory, perform operations comprising:
obtaining an indication of a transmission (TX) profile associated with a service, the TX profile indicating whether sidelink carrier aggregation (CA) is supported for the service;
determining one or more carriers to use for a sidelink transmission based at least on the TX profile associated with the service; and
instructing radio frequency (RF) circuitry to perform the sidelink transmission via the one or more carriers.

22. The one or more processors of claim 21, the operations further comprising determining whether to use packet data convergence protocol (PDCP) duplication for the sidelink transmission based at least on the TX profile associated with the service.

23. The one or more processors of claim 22, wherein determining whether to use PDCP duplication comprises determining to use PDCP duplication for the sidelink transmission when sidelink CA is supported for the service.

24. The one or more processors of claim 22, wherein determining whether to use PDCP duplication comprises determining not to use PDCP duplication for the sidelink transmission when sidelink CA is not supported for the service.

25. The one or more processors of claim 21, the operations further comprising determining whether backwards compatibility is needed for the sidelink transmission based at least on the TX profile associated with the service.

26. The one or more processors of claim 21, wherein obtaining the indication of the TX profile comprises receiving, via the RF circuitry, a radio resource control (RRC) message indicating the TX profile associated with the service.

27. The one or more processors of claim 26, wherein the RRC message comprises a plurality of TX profiles for a plurality of services.

28. The one or more processors of claim 21, wherein determining the one or more carriers to use for the sidelink transmission comprises determining to use a single carrier for the sidelink transmission when sidelink CA is not supported for the service.

29. The one or more processors of claim 21, wherein determining the one or more carriers to use for the sidelink transmission comprises determining to use a plurality of carriers for the sidelink transmission when sidelink CA is supported for the service.

30. The one or more processors of claim 21, wherein the sidelink transmission comprises a broadcast communication or a groupcast communication.

31. The one or more processors of claim 21, wherein determining the one or more carriers to use for the sidelink transmission comprises receiving an indication of the one or more carriers from higher layers.

32. The one or more processors of claim 21, wherein the TX profile corresponds to a legacy user equipment (UE) without sidelink CA capabilities.

33. The one or more processors of claim 21, wherein the TX profile corresponds to a user equipment (UE) with sidelink CA capabilities.

34. A method comprising:
receiving an indication of a transmission (TX) profile associated with a service, the TX profile indicating whether sidelink carrier aggregation (CA) is supported for the service;
determining one or more carriers to use for a sidelink transmission based at least on the TX profile associated with the service; and
performing the sidelink transmission via the one or more carriers.

35. The method of claim 34, further comprising determining whether to use packet data convergence protocol (PDCP) duplication for the sidelink transmission based at least on the TX profile associated with the service.

36. The method of claim 35, wherein determining whether to use PDCP duplication comprises determining to use PDCP duplication for the sidelink transmission when sidelink CA is supported for the service.

37. The method of claim 35, wherein determining whether to use PDCP duplication comprises determining not to use PDCP duplication for the sidelink transmission when sidelink CA is not supported for the service.

38. The method of claim 34, further comprising determining whether backwards compatibility is needed for the sidelink transmission based at least on the TX profile associated with the service.

39. The method of claim 34, wherein receiving the indication of the TX profile comprises receiving a radio resource control (RRC) message indicating the TX profile associated with the service.

40. A user equipment (UE) configured to perform operations comprising:
receiving an indication of a transmission (TX) profile associated with a service, the TX profile indicating whether sidelink carrier aggregation (CA) is supported for the service;
determining one or more carriers to use for a sidelink transmission based at least on the TX profile associated with the service; and
performing the sidelink transmission via the one or more carriers.
